(19) United States
(12) Patent Application Publication
(10) Pub. No.: US 2022/0348806 A1
(43) Pub. Date: Nov. 3, 2022

(54) THREADLIKE ADHESIVE BODY AND METHOD FOR PRODUCING THREADLIKE ADHESIVE BODY

(71) Applicant: NITTO DENKO CORPORATION, Ibaraki-shi, Osaka (JP)

(72) Inventors: Atsushi TAKASHIMA, Ibaraki-shi, Osaka (JP); Ginji MIZUHARA, Ibaraki-shi, Osaka (JP); Hiromitsu MORISHITA, Ibaraki-shi, Osaka (JP)

(21) Appl. No.: 17/765,158

(22) PCT Filed: Sep. 28, 2020
(86) PCT No.: PCT/JP2020/036740

§ 371 Date: Mar. 30, 2022

(30) Foreign Application Priority Data
Sep. 30, 2019 (JP) 2019-179185

(51) Int. Cl. C09J 201/00; D02G 3/36; C09J 7/38; D02G 3/30; D02G 3/04

(52) U.S. Cl. CPC C09J 201/00; D02G 3/36; C09J 7/38; D02G 3/30; D02G 3/042; D10B 2401/06

(57) ABSTRACT

The present invention relates to a threadlike adhesive body including a threadlike core material and an adhesive layer covering a circumferential surface of the core material in a longitudinal direction, in which the core material contains a recycled resin, and a coverage rate of the circumferential surface with the adhesive layer is 50% or more.

### TECHNICAL FIELD

The present invention relates to a threadlike adhesive body and a method for producing the threadlike adhesive body.

### BACKGROUND ART

In recent years, in order to realize a sustainable society, there has been a strong demand for reduction in the environmental load, and in order to reduce the usage amount of materials derived from fossil fuels, there has been a demand for reuse of resources in various fields and materials.

For example, a polyester resin recovered from a used packaging material such as a polyethylene terephthalate (PET) bottle is used as a recycled polyester by enabling the polyester resin to be used again.

As one of products using the recycled polyester, there are a recycled film and a polyester filament yarn that is obtained by remelting and spinning, and the recycled film and the filament yarn are used for industrial materials, clothing, and the like.

However, a plastic product usually contains a large amount of additives or is made of various kinds of resins, and thus, it is impossible to avoid a deterioration in various physical properties such as melt viscosity, molecular weight distribution, and crystallinity, or coloring due to a decrease in viscosity, for a recycled resin. As a result, the recycled resin has wide variations in the physical properties and the physical properties between lots are not very stable. Therefore, a recycled product having sufficient performance as a product cannot be obtained.

The coloring due to a decrease in viscosity may occur, or various physical properties may be deteriorated in reuse even if a product such as a PET bottle, which is made of a transparent single resin containing no additives and has extremely clean content at the time of use, is used.

Therefore, in Patent Literature 1, focusing on a defect of a decrease in heat resistance when recycled PET is used, a resin composition having a high glass transition point, which is made of not a recycled polyester only but a polymer alloy obtained by mixing a thermoplastic resin other than a polyester, such as a polyimide resin or a polyetherimide resin, and a recycled polyester-based resin derived from a polyester bottle, has been studied.

Patent Literature 2 describes a technique for modifying mechanical strength and deterioration resistance by melt-kneading silica particles treated with a silane compound at a high temperature, alumina particles, and a waste polyester resin, in recycling from a waste polyester fiber to a regenerated fiber by remelting.

On the other hand, a threadlike adhesive body, which is an adhesive article including a threadlike core material, has been known. Since such an adhesive article has a threadlike shape, the adhesive article has an advantage of being easily applied to a complicated shape such as a curved line, a curved surface, and an uneven shape, and of being applied to even a narrow part. In addition, unlike a liquid adhesive, there is no risk of dripping, or spilling. In addition, since strength is required for the threadlike core material, a filament made of a resin is used.

### CITATION LIST

### Patent Literature

Patent Literature 1: JP-A-2003-327802

Patent Literature 2: Japanese Patent No. 3265377

### SUMMARY OF INVENTION

### Technical Problem

In the related art, when the mixing ratio of the recycled resin is increased, the obtained resin has various physical properties. Therefore, in a product produced using the resin, a portion where stress is concentrated may be formed, and the strength may be lower than that of a resin not containing the recycled resin.

Therefore, when a recycled resin is used for the core material of the threadlike adhesive body, sufficient strength and stable physical properties of the core material cannot be obtained, and the core material may be broken during a production process or use of the core material.

The present invention has been made in view of the above, and an object of the present invention is to provide a threadlike adhesive body in which a recycled resin having excellent strength is used for a core material. Another object of the present invention is to provide a method for producing a threadlike adhesive body having excellent strength.

### Solution to Problem

As a result of intensive studies to solve the above problems, the present inventors have found that the above problems can be solved by covering a circumferential surface of a core material in a longitudinal direction with an adhesive layer in a threadlike adhesive body in which a recycled resin is used as the core material, and have completed the present invention. That is, the present invention is as follows.

[1]

A threadlike adhesive body including a threadlike core material and an adhesive layer configured to cover a circumferential surface of the core material in a longitudinal direction, in which the core material contains a recycled resin, and a coverage rate of the circumferential surface with the adhesive layer is 50% or more.

[2]

The threadlike adhesive body according to [1], wherein the adhesive layer covers an entire circumference of a surface of the core material in the longitudinal direction.

[3]

The threadlike adhesive body according to [1] or [2], wherein the core material is a multifilament yarn including two or more filaments.

[4]

The threadlike adhesive body according to any one of [1] to [3], wherein a twist coefficient K of the core material represented by the equation (A) is 0 or more and 200 or less.

[Formula 1]

K=T/\sqrt{10000/D} (A)

(In the equation (A), K represents a twist coefficient, T represents the number of twists (unit: [twists/m]), and D represents a fineness (unit: [dtex)].)
[5]

The threadlike adhesive body according to any one of [1] to [4], wherein the number of twists of the core material is 0 to 250 twists/m.

[6]

A method for producing a threadlike adhesive body including a threadlike core material and an adhesive layer configured to cover a circumferential surface of the core material in a longitudinal direction, comprising a step of forming the adhesive layer by applying a coating liquid to the circumferential surface of the core material in the longitudinal direction, wherein the coating liquid has a solution viscosity of 0.03 to 6 Pa s under a condition of a shear rate of 100 (1/s) and a solution viscosity of 2 to 140 Pa s under a condition of a shear rate of 0.1 (1/s).

[7]

A method for producing a threadlike adhesive body including a threadlike core material and an adhesive layer configured to cover a circumferential surface of the core material in a longitudinal direction, comprising a step of forming the adhesive layer by applying a coating liquid to the circumferential surface of the core material in the longitudinal direction, wherein a tension of the core material during coating is 6 mN/dtex or less.

[8]

The method for producing a threadlike adhesive body according to [6] or [7], wherein the core material contains a recycled resin.

[9]

The method for producing a threadlike adhesive body according to any one of [6] to [8], wherein the core material is a multifilament yarn including two or more filaments.

### Advantageous Effects of Invention

The present invention provides a threadlike adhesive body having excellent strength in which a recycled resin is used as a core material.

### BRIEF DESCRIPTION OF DRAWINGS

FIG. 1 is a cross-sectional view of a cross section perpendicular to a longitudinal direction of a threadlike adhesive body including a core material formed of one yarn (monofilament) according to an embodiment of the present invention.

FIG. 2 is a cross-sectional view of a cross section perpendicular to a longitudinal direction of a threadlike adhesive body including a core material formed of two or more filaments (multifilament) according to an embodiment of the present invention.

FIG. 3 is a perspective view for illustrating a method for evaluating the adhesive strength of the threadlike adhesive body of the present invention.

FIG. 4 is a cross-sectional view of a cross section taken along a line A-A of FIG. 3.

FIG. 5 is a schematic view of a state in which adherends are bonded to each other by using the threadlike adhesive body according to the embodiment of the present invention.

FIG. 6 is a schematic view of a state in which adherends are bonded to each other by using the threadlike adhesive body according to the embodiment of the present invention.

### DESCRIPTION OF EMBODIMENTS

Hereinafter, embodiments of the present invention will be described in detail. The present invention is not limited to the embodiments to be described below. In the following drawings, members and parts having the same functions may be described with the same reference numerals, and duplicate descriptions may be omitted or simplified. The drawings of embodiments are schematically described for the purpose of clearly illustrating the present invention, and do not necessarily accurately represent a size or scale of an actual product.

A threadlike adhesive body according to an embodiment of the present invention includes a threadlike core material and an adhesive layer configured to cover a circumferential surface of the core material in a longitudinal direction, in which the core material contains a recycled resin, and a coverage rate of the circumferential surface with the adhesive layer is 50% or more.

Here, the circumferential surface of the core material means a surface that can be visually recognized, that is an entire surface of the core material, which is 0° to 360° with a longitudinal center line of the core material.

The threadlike adhesive body of the present embodiment is excellent in strength by having the above configuration. The detailed description is as follows.

A threadlike adhesive body having excellent strength can be obtained by covering the circumferential surface of the core material in the longitudinal direction with an adhesive layer. It is presumed that this is because, in the part covered with the adhesive layer, the core material hardly comes out to the surface, and when stress is applied, the movement of each filament is suppressed by the adhesive layer, and whereby the break due to rubbing can be prevented, and also, unevenness is hardly generated on the surface of the threadlike adhesive body, and the break due to stress concentration on a part of the core material can be prevented.

The coverage rate of the circumferential surface of the core material with the adhesive (area (%) of the adhesive layer per unit area of the visually recognizable surface of the core material) is preferably 100%, and is preferably 50% or more, more preferably 80% or more, still more preferably 90% or more, and particularly preferably 95% or more.

When the coverage rate of the circumferential surface of the core material with the adhesive is 50% or more, break of the core material can be prevented, and the threadlike adhesive body having excellent strength can be obtained.

The threadlike adhesive body according to an embodiment of the present invention may include a threadlike core material and an adhesive layer configured to cover an entire circumference of a surface of the core material in a longitudinal direction, and the core material may contain a recycled resin.

Here, the entire circumference of the core material refers to the entire circumferential surface of the core material, and means the entire circumference of the surface of the core material, which is 360° with the longitudinal center line of the core material.

Further, since the recycled resin is enabled to be used again after collecting the used resin product, there is a concern that contamination may occur in the process of being recycled, and it is difficult to obtain the hygiene reliability from consumers. However, hygiene can be obtained since the recycled resin does not come out to the surface when the circumferential surface of the core material in the longitudinal direction is covered with the adhesive layer with a high coverage rate.

The core material according to the embodiment of the present invention is preferably a multifilament yarn including two or more filaments.

The threadlike shape means a shape in which a length in the longitudinal direction is sufficiently long with respect to a length in the width direction, and a ratio (long axis/short axis) of a length of a long axis (the longest axis among the axes passing through the center of gravity of a cross-sectional shape) to a length of a short axis (the shortest axis among the axes passing through the center of gravity of the cross-sectional shape) in the shape of a cross section perpendicular to the longitudinal direction (hereinafter, also referred to as “cross-sectional shape”) is, for example, 200 or less, preferably 100 or less, more preferably 50 or less, still more preferably 10 or less, yet still more preferably 5 or less, and particularly preferably 3 or less. Further, the threadlike shape means a state in which the threadlike adhesive body can be bent in various directions and angles like a yarn.

Since the threadlike adhesive body can be bent in various directions and angles as described above, the threadlike adhesive body can be bent in accordance with a shape of a region to be bonded, and therefore, the threadlike adhesive body can cope with the diversification of the shape of the region to be bonded.

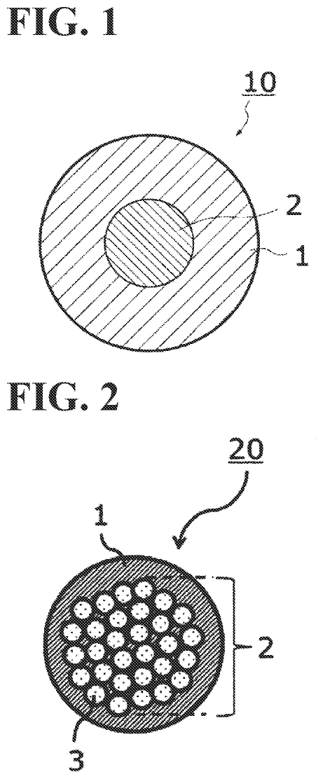

FIG. 1 is a cross-sectional view of a cross section perpendicular to a longitudinal direction of a threadlike adhesive body 10 according to an embodiment of the present invention. The threadlike adhesive body 10 shown in FIG. 1 includes a threadlike core material 2 and an adhesive layer 1 that covers a circumferential surface of the core material 2 in a longitudinal direction.

FIG. 2 is a cross-sectional view of a cross section perpendicular to a longitudinal direction of a threadlike adhesive body 20 according to an embodiment of the present invention. The threadlike adhesive body 20 according to the present embodiment includes a core material 2 and an adhesive layer 1 that covers a circumferential surface of the core material 2 in a longitudinal direction, and the core material 2 is a multifilament yarn including two or more filaments 3.

The threadlike adhesive bodies according to the embodiments of the present invention will be described in detail below.

### [Core Material]

The core material according to the embodiment of the present invention contains a recycled resin. When a recycled resin is used for the core material in the threadlike adhesive body, not only the utilization rate of the recycled resin in the threadlike adhesive body is improved, but also the utilization rate of the recycled resin in a bonded body bonded using the threadlike adhesive body is improved.

The recycled resin in the present invention is a resin obtained by recycling a resin product, and includes resins obtained by material recycling and chemical recycling.

The material recycling indicates that a resin product such as waste plastic is recycled and used as a raw material of a resin product after being subjected to a treatment such as crushing and melting.

The chemical recycling indicates that a resin product such as waste plastic is chemically decomposed by raw material/monomerization, blast furnace reduction, coke oven chemical raw material conversion, gasification, oilization, or the like to obtain a petroleum raw material or the like, and reused as a raw material of a resin product.

The kind of the recycled resin is not particularly limited, and may be appropriately selected according to properties such as required strength, mass, and hardness. Examples of the recycled resin include materials containing polymeric materials such as various thermoplastic polymers, thermosetting polymers and rubber, and examples of the materials include: various polymeric materials such as rayon, cupra, acetate, promix, nylon, aramid, vinylon, vinylidene, polyvinyl chloride, polyesters, acrylic, polyolefins such as polyethylene (PE), polypropylene (PP), ethylene-propylene copolymers, and ethylene-vinyl acetate copolymers, polyester resins such as polyethylene terephthalate (PET), vinyl chloride resins, vinyl acetate resins, polyimide resins, polyamide resins, fluororesins, polyurethane, polyclar, polylactic acid; various rubbers such as natural rubber and synthetic rubber such as polyurethane; foams such as foamed polyurethane and foamed polychloroprene rubber; and the like. A polyester resin is preferred, and polyethylene terephthalate (PET) is more preferred.

The recycled resin may contain a non-recycled resin, that is, a commercially available polymer or a newly synthesized polymer. The kind of the non-recycled resin is not particularly limited, and examples thereof include materials containing polymeric materials such as various thermoplastic polymers, thermosetting polymers, rubbers or the like. The thermoplastic polymers are preferred, the same kind of resin as the above-described recycled resin is preferred, the polyester resins are preferred, and polyethylene terephthalate (PET) is more preferred.

The content of the recycled resin in the core material is preferably 70 mass % or more, more preferably 80 mass % or more, and still more preferably 95 mass % or more, from the viewpoint of reducing the environmental load.

The core material may contain various additives such as a filler (an inorganic filler, an organic filler, etc.), an anti-aging agent, an antioxidant, an ultraviolet absorber, an antistatic agent, a lubricant, a plasticizer, and a colorant (a pigment, a dye, etc.) as necessary. The known or common surface treatment such as a corona discharge treatment, a plasma treatment or application of an undercoat agent may be performed on the surface of the core material.

The form of the core material is not particularly limited, and may be appropriately adjusted according to required properties such as strength, mass, and hardness.

The cross-sectional shape of the core material in the threadlike adhesive body is typically a circular shape, and may be various shapes such as an elliptical shape and a polygonal shape in addition to the circular shape.

The core material in the threadlike adhesive body may be a monofilament composed of a single filament, may be a multifilament composed of a plurality of filaments, may be a spun yarn, may be a processed yarn generally referred to as a textured yarn, a bulky yarn or a stretch yarn, which is subjected to crimping, bulking, or the like, may be a hollow yarn, or may be a yarn obtained by combining these yarns by twisting them or the like.

The thickness of the core material is not particularly limited, and may be appropriately adjusted together with the thickness of the adhesive layer so that the thickness of the threadlike adhesive body is appropriate depending on its use.

In the core material according to the embodiment of the present invention, the circumferential surface of the core material in the longitudinal direction is covered with the adhesive layer. However, an end surface of the core material may or may not be covered with the adhesive layer. For example, when the adhesive body is cut during a producing process or during use, the end surface of the core material may not be covered with the adhesive layer.

In order to achieve a high adhesive strength, the threadlike adhesive body preferably includes a multifilament yarn as the core material.

The adhesive strength (resistance to peeling between articles) generated when a plurality of articles are bonded by the threadlike adhesive body is greatly influenced by the contact area between the threadlike adhesive body and the article.

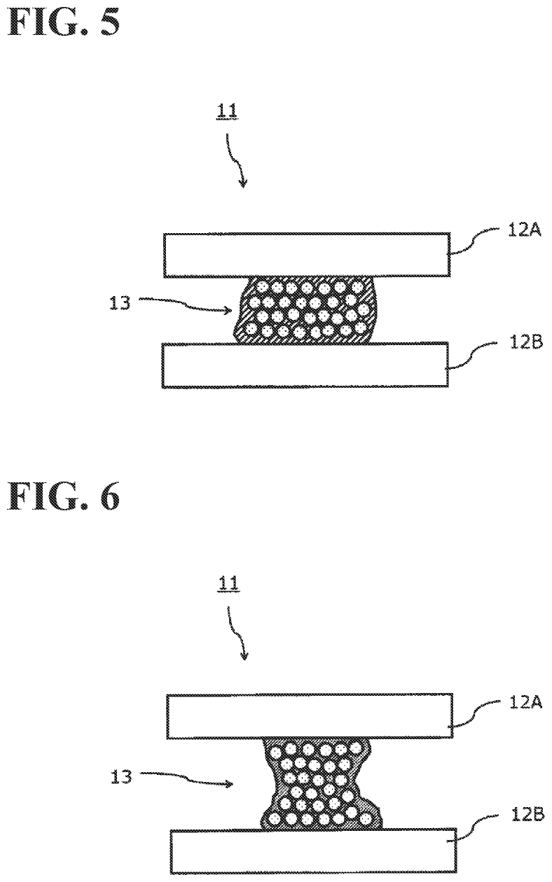

FIG. 5 is a schematic view of a bonded body 11 obtained by bonding an article 12A to an article 12B by using a threadlike adhesive body 13 including a core material formed of a multifilament yarn. When articles are bonded using the threadlike adhesive body 13 including a multifilament yarn as a core material, each filament constituting the core material spreads in a manner of being released, and the core material is deformed in a manner of being crushed. As a result, the article 12A and the article 12B can be brought into contact with the threadlike adhesive body in a wide area, so that a high adhesive strength can be obtained.

For the reason described above, the threadlike adhesive body 13 including the multifilament yarn as the core material exhibits a higher adhesive strength as compared with the threadlike adhesive body including the core material formed of the monofilament under a condition of the same thicknesses (fineness) of the core materials.

When the multifilament yarn is used as the core material, the number of filaments constituting the multifilament is preferably 2 or more, more preferably 10 or more, still more preferably 15 or more, and particularly preferably 20 or more, from the viewpoint of the adhesive strength.

On the other hand, in the case where the thickness (fineness) of the core material is kept at the same level, as the number of filaments constituting the core material increases, each filament becomes thinner (the fineness decreases). When each filament is too thin, the strength of the core material may be lowered and the handleability may be deteriorated. Therefore, the number of filaments constituting the core material is preferably 300 or less.

The multifilament yarn may be a twisted yarn that is twisted, or may be a non-twisted yarn that is not twisted. That is, the number of twists of the multifilament yarn may be above 0 twist/m, or may be 0 twist/m. In addition, the multifilament yarn may be a yarn in which a plurality of multifilaments, which are twisted yarns or non-twisted yarns, are bundled with being twisted or without being twisted.

In the case where a force is applied in a direction in which articles which are bonded using a threadlike adhesive body including a multifilament yarn as a core material are peeled from each other, each filament expands and the core material deforms in a manner of extending in a direction parallel to the force applied in a thickness direction (a direction perpendicular to the longitudinal direction), as shown in FIG. 6. However, when the shape of the core material becomes too distorted at this time, stress is concentrated at the distorted part, and the part is likely to become a starting point of peeling. Therefore, in order to exhibit excellent adhesive strength, it is preferable that each filament constituting the core material has a certain degree of cohesion. As described above, the core material may be a non-twisted yarn or a twisted yarn, that is, the number of twists of the core material in the present embodiment may be 0 twist/m or more, and in order to allow each filament constituting the core material to have a certain degree of cohesion, it is preferable that the core material is twisted. Specifically, the number of twists of the core material is preferably 30 twists/m or more, more preferably 60 twists/m or more, and still more preferably 90 twists/m or more.

On the other hand, since the core material is sufficiently deformed when the plurality of articles are bonded to each other, the twisting of the core material is preferably not too strong in order to increase the adhered amount of the adhesive per unit length. Therefore, the number of twists of the core material is preferably 3000 twists/m or less, more preferably 1500 twists/m or less, still more preferably 800 twists/m or less, and particularly preferably 250 twists/m or less.

In the case where the core material is twisted, it is preferable to control the twist coefficient K represented by the following equation (A) from the same viewpoint as described above. The twist coefficient is an index for discussing the influence of the twisting (influence on the cohesion of the core material, the ease of deformation, the adhered amount of the adhesive, etc.) regardless of the thickness of the core material. That is, the influence of the number of twists on the core material varies depending on the thickness of the core material, but if the twist coefficients are the same, it is indicated that the influences of the twisting on the core material are the same regardless of the thickness of the core material.

The twist coefficient K of the core material is preferably 0 or more, and more preferably above 0. On the other hand, when the twist coefficient K is 200 or less, the flexibility of the core material and the threadlike adhesive body is improved, and the threadlike adhesive body is easily stuck to a complicated shape such as a curved portion, a bent portion, and an uneven portion or a narrow part. Therefore, the twist coefficient of the core material is preferably 200 or less, more preferably 100 or less, and still more preferably less than 50.

[Formula 2]

K=T/\sqrt{10000/D} (A)

In the equation (A), K represents a twist coefficient, T represents the number of twists (unit: [twists/m]), and D represents a fineness (unit: [dtex]).

The filament for forming the core material may be a hollow yarn. In general, since the hollow yarn is rich in flexibility in the thickness direction and is easily deformed, the core material obtained by using the hollow yarn is also rich in flexibility in the thickness direction and is easily deformed.

Therefore, in the case where the hollow yarn is used as the filament for forming the core material, the crushing deformation of the core material described above is more likely to occur. When the flexibility of the core material is high, stress generated by deformation of the core material is likely to disperse when a force is applied in a direction in which adherends which are bonded using the threadlike adhesive body are peeled from each other. Therefore, stress is hardly applied to an interface (adhesive surface) between the threadlike adhesive body and the adherend, and peeling is hardly generated. From the above points, when the hollow yarn is used as the filament forming the core material, a threadlike adhesive body having excellent adhesive strength can be obtained.

Since the hollow yarn is generally brittle, the hollow yarn is preferably used without being twisted when the hollow yarn is used as the filament forming the core material.

### [Adhesive Layer]

The adhesive layer covering the circumferential surface of the core material in the longitudinal direction can be formed of an adhesive.

The kind of the adhesive to be used is not particularly limited, and examples thereof include an acrylic adhesive, a rubber-based adhesive, a vinyl alkyl ether-based adhesive, a silicone-based adhesive, a polyester-based adhesive, a polyamide-based adhesive, a urethane-based adhesive, a fluorine-based adhesive, and an epoxy-based adhesive. Among them, the rubber-based adhesive and the acrylic adhesive are preferred, and the acrylic adhesive is particularly preferred, from the viewpoint of adhesiveness. One kind of the adhesives may be used alone, or two or more kinds thereof may be used in combination.

The acrylic adhesive contains, as a main component, a polymer of monomers that mainly contain an alkyl (meth)acrylate such as ethyl acrylate, butyl acrylate, 2-ethylhexyl acrylate, isooctyl acrylate, and isononyl acrylate, and is obtained by adding remodeling monomers, such as acrylonitrile, vinyl acetate, styrene, methyl methacrylate, acrylic acid, methacrylic acid, maleic anhydride, vinylpyrrolidone, glycidyl methacrylate, dimethylaminoethyl methacrylate, hydroxyethyl acrylate, acrylamide, and γ-methacryloxypropyltrimethoxysilane, to the alkyl (meth)acrylates as necessary.

The rubber-based adhesive contains, as a main component, a rubber-based polymer such as natural rubber, a styrene-isoprene-styrene block copolymer, a styrene-butadiene-styrene block copolymer, a styrene-ethylene-butylene-styrene block copolymer, a styrene-butadiene rubber, polybutadiene, polyisoprene, polyisobutylene, butyl rubber, chloroprene rubber, and silicone rubber.

These adhesives may be appropriately blended with various additives such as adhesive-imparting resins, for example, a rosin-based resin, a terpene-based resin, a styrene-based resin, an aliphatic petroleum-based resin, an aromatic petroleum-based resin, an xylene-based resin, a phenol-based resin, a coumarone-indene-based resin, and hydrogenated products thereof, a crosslinking agent, a polymerization initiator, a chain transfer agent, an emulsifier, a viscosity modifier (a thickener, etc.), a leveling agent, a release modifier, a plasticizer, a softener, a filler, a colorant (a pigment, a dye, etc.), a surfactant, an antistatic agent, a preservative, an anti-aging agent, an ultraviolet absorber, an antioxidant, and a light stabilizer.

As the adhesive, both types of a solvent type adhesive and a water-dispersible type adhesive may be used. Here, from the viewpoint of enabling high-speed coating, being environmentally friendly, and having a small influence (swelling or dissolving) on the core material caused by the solvent, the water-dispersible adhesive is preferred.

In the threadlike adhesive body according to the embodiment of the present invention, the circumferential surface of the core material in the longitudinal direction is covered with the adhesive layer. That is, the adhesive preferably adheres to the circumferential surface of the core material. In the case where the circumferential surface of the core material is covered with the adhesive at a high coverage rate, the recycled resin hardly comes out to the surface. Therefore, hygiene is obtained, and further, a threadlike adhesive body having excellent strength can be obtained. Therefore, it is preferable that the adhesive adheres to the entire circumference of the core material.

In addition, it is preferable that a surface of the adhesive layer has a small number of lumps and slight unevenness.

When a recycled resin is used for the core material of the threadlike adhesive body, the strength is inferior to that a non-recycled resin is used for, and thus the threadlike adhesive body is likely to be broken. However, the present inventors have found that the threadlike adhesive body according to the related art has a core material with a part that is not covered, which causes a decrease in strength and a variation in physical properties. In the threadlike adhesive body according to the embodiment of the present invention, the circumferential surface of the core material is covered with the adhesive. Accordingly, it is possible to obtain a threadlike adhesive body having sufficient strength even when a recycled resin is used for the core material.

For example, in the case where the core material in the threadlike adhesive body is a multifilament, it is presumed that by covering the circumferential surface of the core material with the adhesive, the adhesive permeates also the inside of the multifilament to play a role like a lubricating oil, and the friction between the filaments is alleviated, so that break can be prevented. In addition, it is presumed that when the threadlike adhesive body is used, stress is prevented from being concentrated on a part of the filaments and break is prevented. As a result, break of the core material can be prevented, and the threadlike adhesive body having excellent strength can be obtained.

The threadlike adhesive body can be obtained, for example, by applying an adhesive (coating liquid) to the surface of the core material by dipping, immersion, coating, or the like, and heating and drying as necessary. The adhesive can be applied by using a conventional coater such as a gravure roll coater, a reverse roll coater, a kiss roll coater, a dip roll coater, a bar coater, a knife coater, and a spray coater.

The adhesive layer can be formed on the circumferential surface of the core material in the longitudinal direction and can cover the core material by adjusting the viscosity of the adhesive used as the coating liquid, the tension during coating, the drying conditions, and the like, and, as necessary, adjusting the composition of the adhesive, the oil agent used for the core material, and a change of a surface state and a shape of the core material.

In addition, it is preferable that the threadlike adhesive body is produced by a method for producing the threadlike adhesive body described below.

Specifically, the adhered amount of the adhesive (the mass of the adhesive layer per unit length) is preferably 2 mg/m or more, more preferably 5 mg/m or more, and still more preferably 8 mg/m or more. On the other hand, when the adhered amount of the adhesive is excessive, it is necessary to apply the adhesive to the core material a plurality of times during the production process, or it takes time to dry the applied adhesive, resulting in a low production efficiency. Therefore, the adhesion amount of the adhesive is preferably 200 mg/m or less, more preferably 180 mg/m or less, and still more preferably 160 mg/m or less.

The coverage rate of the circumferential surface of the core material with the adhesive (the area (%) of the adhesive layer per unit area of the visually recognizable surface of the core material) is preferably 100% as described above, and is preferably 50% or more, more preferably 80% or more, still more preferably 90% or more, and particularly preferably 95% or more. When the coverage rate is 50% or more, break of the core material can be prevented, and a threadlike adhesive body having excellent strength can be obtained.

The coverage rate of the core material may be calculated using, for example, an X-ray CT apparatus (Xradia 520 Versa, manufactured by Zeiss, tube voltage: 60 kV, tube current: 83 μA, pixel size: 1.5 μm/pixel). Specifically, 1601 continuous transmission images are captured from 0° to 360° of the surface of the core material with the longitudinal center line of the core material of the threadlike adhesive body. With respect to data obtained by three-dimensionally reconstructing the obtained images using image analysis software (ImageJ, AVIZO (manufactured by Thermo Fisher Scientific Inc.)), the core material, the adhesive, and the air are identified by subjecting to ternarization and noise removal based on luminance. The area of an interface (Interface 1) between the core material and the air and the area of an interface (Interface 2) between the adhesive and the air are calculated using images obtained by the ternarization, and the coverage rate is determined by the following equation.

Coverage rate (%)={area of Interface 2/(area of Interface 1+area of Interface 2)}×100

The interface 1 and the interface 2 do not include an interface between the air and the core material or the adhesive inside the threadlike adhesive body.

It is preferable that the adhesive layer has a small number of lumps and slight unevenness on the surface and has a uniform thickness.

In this case, the thickness of the adhesive layer is not particularly limited, and can be appropriately selected according to the use of the threadlike adhesive. In general, the thickness of the adhesive layer is appropriately about 3 μm to 150 μm, and preferably about 5 μm to 50 μm.

The adhesive strength of the threadlike adhesive body may be evaluated by, for example, the following method.

### (Evaluation Method of Adhesive Strength)

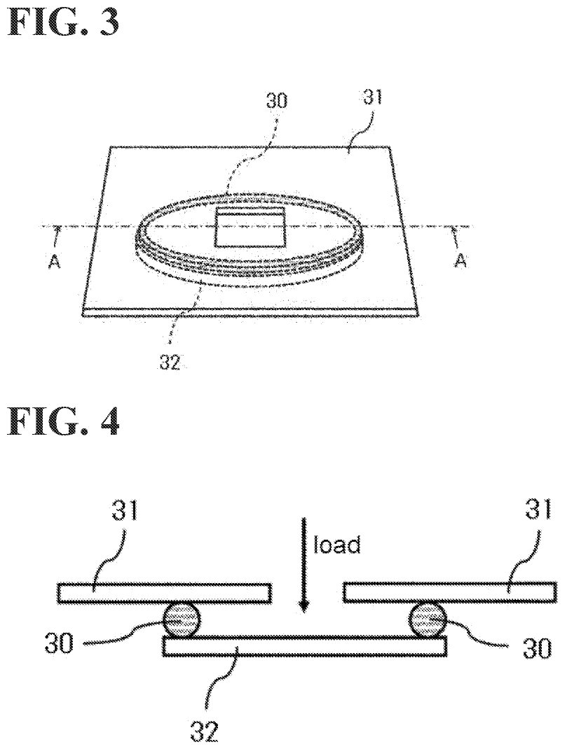

Using a threadlike adhesive body 30, a circular acrylic plate 32 having a thickness of 3 mm and a diameter of 70 mm and a rectangular polycarbonate resin plate 31 (a short side of 80 mm, a long side of 110 mm, and a thickness of 10 mm) provided with a rectangular slit (a short side of 30 mm, and a long side of 40 mm) in a central portion thereof are bonded to each other such that a center of the acrylic plate 32 and a center of the slit of the polycarbonate resin plate 31 coincide with each other, and are pressure-bonded at a load of 2 kg for 10 seconds. As shown in FIGS. 3 and 4, the threadlike adhesive body 30 is disposed along an edge of the acrylic plate. FIG. 3 is a perspective view of the bonded state, and FIG. 4 is a cross-sectional view taken along a line A-A of FIG. 3.

Next, the polycarbonate resin plate 31 is fixed, and as shown in FIG. 4, a load is applied to the center of the acrylic plate 32 through the slit in a direction in which the acrylic plate 32 and the polycarbonate resin plate 31 are away from each other, and the maximum load observed before the acrylic plate 32 and the polycarbonate resin plate 31 are separated from each other is measured.

The threadlike adhesive body according to the embodiment of the present invention preferably has a strength at break of 30 mN/dtex or more. A strength at break of 30 mN/dtex or more is preferred because of imparting handleability and reworkability. The strength at break is preferably 32 mN/dtex or more, more preferably 34 mN/dtex or more, and still more preferably 36 mN/dtex or more. From the viewpoint of ease of cutting during use, the strength at break is preferably 80 mN/dtex or less, more preferably 70 mN/dtex or less, and still more preferably 60 mN/dtex or less.

The strength at break of the threadlike adhesive body may be measured by a method described in Examples.

### [Method for Producing Threadlike Adhesive Body]

A method for producing a threadlike adhesive body according to the embodiment of the present invention is a method for producing a threadlike adhesive body including a threadlike core material and an adhesive layer covering a circumferential surface of the core material in a longitudinal direction. The method includes a step of forming the adhesive layer by applying a coating liquid to the circumferential surface of the core material in the longitudinal direction, in which the coating liquid has a solution viscosity of 0.03 to 6 Pa s at a shear rate of 100 (1/s) and a solution viscosity of 2 to 140 Pa sat a shear rate of 0.1 (1/s).

Here, the solution viscosity (Pa s) at a shear rate of 100 (1/s) and the solution viscosity (Pa s) at a shear rate of 0.1 (1/s) are a viscosity of a coating liquid measured when the shear rate is changed from a high rate (viscosity decrease) to a low rate (viscosity recovery).

Specifically, 1 g of a sample (coating solution) is placed in a measurement plate (MP35 Steel, 18/8, sensor: Rotor C35/1, Cone with D=35 mm, 1° Titan, gap between plates: 0.225 mm), and the solution viscosity (Pa s) of the coating liquid is first measured at a shear rate of 0.01 (1/s) for 10 seconds under a condition of 23° C. using a viscosity-viscoelasticity measuring device (rheometer, trade name “RS-600”, manufactured by HAAKE). Thereafter, the shear rate is changed to 9000 (1/s) (A) over 20 seconds, and then, the shear rate returns to 0.01 (1/s) (B) over 20 seconds, and the solution viscosity (Pa s) of the coating liquid during this period is measured.

A value of the solution viscosity (Pa s) of the coating liquid at a time point when a shear rate is 100 (1/s) during the period in which the above shear rate is changed to 9000 (1/s) (A) is the solution viscosity (Pa s) at a shear rate of 100 (1/s). A value of the solution viscosity (Pa s) of the coating liquid at a time point when a shear rate is 0.1 (1/s) during the period in which the shear rate returns to 0.01 (1/s) (B) is the solution viscosity (Pa s) at a shear rate of 0.1 (1/s).

The solution viscosity of the coating liquid at a shear rate of 100 (1/s) is predicted to be approximate to the viscosity of the coating liquid during coating.

When the solution viscosity at a shear rate of 100 (1/s) is higher than 6 Pa s, the coating liquid does not flow, and the coating liquid is not applied to the core material, causing lumps or unevenness. Accordingly, there is a concern that the coated surface is roughened and the core material is exposed.

The solution viscosity of the coating liquid at a shear rate of 100 (1/s) is preferably 0.03 Pa s or more, more preferably 0.05 Pa s or more, and still more preferably 0.07 Pa s or more, from the viewpoint of preventing exposing of the core material due to the fact that the core material is not coated with the coating liquid. In addition, in order to prevent the roughening of the coated surface and the exposing of the core material due to the fact that the coating liquid does not flow and the coating liquid is not applied to the core material, which causes lumps or unevenness, the solution viscosity of the coating liquid at a shear rate of 100 (1/s) is preferably 6 Pa s or less, more preferably 5 Pa s or less, and still more preferably 4 Pa s or less.

The solution viscosity of the coating liquid at a shear rate of 0.1 (1/s) indicates the degree of fluidity of the coating liquid from coating to drying.

When the solution viscosity at a shear rate of 0.1 (1/s) is lower than 2 Pa s, there is a concern that the core material is exposed since the coating liquid is repelled in the process from coating to drying.

In order to prevent the core material from being exposed due to the repelling of the coating liquid in the process from coating to drying, the solution viscosity of the coating liquid at a shear rate of 0.1 (1/s) is preferably 2 Pa s or more, more preferably 4 Pa s or more, and still more preferably 6 Pa s or more. In addition, from the viewpoint of leveling properties, the solution viscosity of the coating liquid at a shear rate of 0.1 (1/s) is preferably 140 Pa s or less, more preferably 120 Pa s or less, and still more preferably 100 Pa s or less.

The solution viscosity of the coating liquid may be measured by a method described in Examples.

In order to provide the adhesive layer preferably at a uniform thickness on the circumferential surface of the core material, it is preferable that the coating liquid changes from a state of having a solution viscosity of 0.03 to 6 Pa s under a condition of a shear rate of 100 (1/s) to a state of having a solution viscosity of 2 to 140 Pa s under a condition of a shear rate of 0.1 (1/s) in a short time.

A method for producing a threadlike adhesive body according to another embodiment of the present invention is a method for producing a threadlike adhesive body including a threadlike core material and an adhesive layer covering a circumferential surface of the core material in a longitudinal direction. The method includes a step of forming the adhesive layer by applying a coating liquid to the circumferential surface of the core material in the longitudinal direction, in which a tension of the core material during coating is 6 mN/dtex or less.

When the tension of the core material during coating is more than 6 mN/dtex, the cross section of the core material is close to a circle, gaps between the filaments are eliminated, a balance between the retention of the coating liquid and the leveling property is not achieved, and an adhesive layer having a uniform thickness cannot be formed.

The tension of the core material during coating is preferably 0.2 mN/dtex or more, more preferably 0.4 mN/dtex or more, and still more preferably 0.6 mN/dtex or more, because unevenness may occur in the formation of the adhesive layer even if the tension is too low, and in the case where the core material is a multifilament, the filaments are released and the appearance is impaired. In addition, the tension of the core material is preferably 6 mN/dtex or less, more preferably 5 mN/dtex or less, and still more preferably 4 mN/dtex or less, from the viewpoint of preventing unevenness in the formation of the adhesive layer and preventing spreading or break of the core material.

The tension of the core material may be measured by a method described in Examples using, for example, a digital force gauge (AD-4932A).

According to the method for producing the threadlike adhesive body in the embodiment of the present invention, the adhesive layer can be uniformly formed on the circumferential surface of the core material, and the threadlike adhesive body having excellent strength can be produced.

### [Member, Bonded Body, and Method for Producing Bonded Body]

The shape of the region to be bonded is not particularly limited. An example of the shape of the region to be bonded is a frame-like shape along an outer shape of a surface to be bonded of one article (the surface facing another article of the bonded body). For example, in the case where a cover glass of a display or a cover glass of a camera of a smartphone or the like is bonded to a frame member, such a shape of the region to be bonded is required.

The kind of the member to be bonded is also not particularly limited, and it is preferable that the member is a member constituting an electronic device since the shape of the region to be bonded is particularly required to be narrow and complicated in the bonding of parts of the electronic device.

Examples of the member constituting the electronic device include various wire members (linear members) such as cables, for example, electric wires and optical fibers, and optical fiber sensors, for example, LED fiber lights and fiber bragg gratings (FBG), in addition to the cover glass and the frame member described above. When these members are stuck and fixed to another member in a bent state, the region to be bonded also has a narrow bent shape in accordance with the shape of the linear member.

In the method for producing a bonded body of the present embodiment, it is preferable that the threadlike adhesive body is first stuck to one member, and then another member is stuck to the one member. The method for sticking the threadlike adhesive body to the member is not particularly limited, and the threadlike adhesive body may be stuck by using a sticking machine (sticking apparatus), or may be stuck manually, or may be stuck on a temporary support once and transferred to the member.

Note that, in the bonding of the members (that is, the production of the bonded body), a plurality of threadlike adhesive bodies may be used, and only one adhesive body is preferably used from the viewpoint of reducing the number of man-hours.

### Examples

Hereinafter, the present invention will be described in detail with reference to Examples, but the present invention is not limited to these Examples.

(Preparation of Water-Dispersible Type Acrylic Adhesive 1) Into a reaction vessel equipped with a cooling tube, a nitrogen introduction tube, a thermometer, and a stirrer, 40 parts by mass of ion-exchanged water was added, and stirring was performed at 60° C. for 1 hour or more while introducing nitrogen gas to carry out nitrogen substitution. To this reaction vessel, 0.1 parts by mass of 2,2′-azobis[N-(2-carboxyethyl)-2-methylpropionamidine]n hydrate (polymerization initiator) was added. While the system was maintained at 60° C., a monomer emulsion A was gradually added dropwise thereto over 4 hours to allow an emulsion polymerization reaction to proceed. Examples of the monomer emulsion A include an emulsion obtained by adding 98 parts by mass of 2-ethylhexyl acrylate, 1.25 parts by mass of acrylic acid, 0.75 parts by mass of methacrylic acid, 0.05 parts by mass of lauryl mercaptan (chain transfer agent), 0.02 parts by mass of γ-methacryloxypropyltrimethoxysilane (manufactured by Shin-Etsu Chemical Co., Ltd., trade name “KBM-503”), and 2 parts by mass of sodium polyoxyethylene lauryl sulfate (emulsifier) to 30 parts by mass of ion-exchanged water. After completion of the dropwise addition of the monomer emulsion A, the system was further kept at 60° C. for 3 hours and cooled to room temperature, and pH was then adjusted to 7 by addition of 10% ammonia water to obtain an acrylic polymer emulsion (water-dispersible acrylic polymer).

An adhesive-imparting resin emulsion (manufactured by Arakawa Chemical Industries, Ltd., trade name “E-865NT”) was added in an amount of 10 parts by mass based on the solid content per 100 parts by mass of the acrylic polymer contained in the above acrylic polymer emulsion. Further, ion-exchanged water was added to adjust the solid content to 45%, thereby obtaining a water-dispersible acrylic adhesive 1 for an adhesive layer.

### (Production of Threadlike Adhesive Body)

Each of core materials of Production Examples 1 and 2 was obtained by intertwining two recycled PET yarns (180 dtex, the number of filaments: 48, non-twisted yarn, recycling rate: 95%) without twisting.

A core material of Production Example 3 was obtained by intertwining a PET yarn (167 dtex, the number of filaments: 48, non-twisted yarn) containing no recycled resin without twisting.

The water-dispersible acrylic adhesive 1 prepared above was applied to the core material of each of Production Examples 1 to 3 by dipping at a conveyance speed of 1 m/min with a tension shown in Table 1, and then dried at 80° C. for 5 minutes to form an adhesive layer, thereby obtaining a threadlike adhesive body of each of Production Examples 1 to 3.

The threadlike adhesive bodies of Production Examples 1 to 3 exhibited sufficient adhesive strength.

A threadlike adhesive body of Production Example 4 was not provided with an adhesive layer and only had a core material formed of PET yarns (two recycled PET yarns (180 dtex, the number of filaments: 48, non-twisted yarn, recycling rate: 95%)).

The production conditions and evaluation results of the threadlike adhesive bodies of Production Examples 1 to 4 are shown in the following Table 1.

[Table 1]

TABLE 1

| | | Solution viscosity | | | | | |
|---|---|---|---|---|---|---|---|
| | | (Pa s) | | | | Strength | |
| | Tension | Shear | Shear | | Coverage | at break | Adhesive |
| | mN/dtex | rate 100 | rate 0.1 | Appearance | rate (%) | mN/dtex | Strength N/22 cm |
| Production | 4.4 | 0.2 | 12 | A | 97 | 36.1 | 40 |
| Example 1 | | | | | | | |
| Production | 8.3 | 0.2 | 12 | B | 98 | 30.6 | 28 |
| Example 2 | | | | | | | |
| Production | 4.8 | 0.2 | 12 | A | 69 | 61.1 | 40 |
| Example 3 | | | | | | | |
| Production | — | — | — | — | — | 27.8 | — |
| Example 4 | | | | | | | |

### (Tension)

The tension of the core material was measured using a digital force gauge (AD-4932A) during coating. Specifically, the tension between a feeding point of the core material and a coating roll was measured by reading the stress applied to a terminal of the force gauge.

### (Viscosity)

The viscosity of the coating liquid was measured when the shear rate was changed from a high speed (viscosity decrease) to a low speed (viscosity recovery).

Specifically, 1 g of a sample (coating solution) was placed in a measurement plate (MP35 Steel, 18/8, sensor: Rotor C35/1, Cone with D=35 mm, 1° Titan, gap between plates: 0.225 mm), and the solution viscosity (Pa s) of the coating liquid was first measured at a shear rate of 0.01 (1/s) for 10 seconds under a condition of 23° C. using a viscosity-viscoelasticity measuring device (rheometer, trade name “RS-600”, manufactured by HAAKE). Thereafter, the shear rate was changed to 9000 (1/s) (A) over 20 seconds, and then, the shear rate returned to 0.01 (1/s) (B) over 20 seconds, and the solution viscosity (Pa s) of the coating liquid during this period was measured.

A value of the solution viscosity (Pa s) of the coating liquid at a time point when a shear rate was 100 (1/s) during the period in which the above shear rate was changed to 9000 (1/s) (A) was the solution viscosity (Pa s) at a shear rate of 100 (1/s), and is shown in Table 1. A value of the solution viscosity (Pa s) of the coating liquid at a time point when a shear rate was 0.1 (1/s) during the period in which the shear rate returned to 0.01 (1/s) (B) was the solution viscosity (Pa s) at a shear rate of 0.1 (1/s), and is shown in Table 1.

### (Appearance)

With respect to the threadlike adhesive bodies in Production Examples, a state of coating of the adhesive layer was visually determined according to the following determination criteria.

A: No unevenness was observed on the surface.

B: The surface was uneven or had lumps.

### (Coverage Rate)

The coverage rate of the core material was calculated using an X-ray CT apparatus (Xradia 520 Versa, manufactured by Zeiss, tube voltage: 60 kV, tube current: 83 μA, pixel size: 1.5 μm/pixel). Continuous transmission images were captured in an amount of 1601 from 0° to 360° of the surface of the core material with the longitudinal center line of the core material of the threadlike adhesive body. With respect to data obtained by three-dimensionally reconstructing the obtained images using image analysis software (ImageJ, AVIZO (manufactured by Thermo Fisher Scientific Inc.)), the core material, the adhesive, and the air were identified by subjecting to ternarization and noise removal based on luminance. The area of an interface (Interface 1) between the core material and the air and the area of an interface (Interface 2) between the adhesive and the air were calculated using images obtained by the ternarization, and the coverage rate was determined by the following equation.

Coverage rate (%)={area of Interface 2/(area of Interface 1+area of Interface 2)}×100

### (Strength at Break)

For the threadlike adhesive bodies and the core materials in Production Examples 1 to 4, the strength at break was calculated according to the following procedure.

First, each of the threadlike adhesive bodies and the core materials was cut into 150 mm Next, an autograph was set such that the interval between the chuck portions is 100 mm, and a sample was obtained. Thereafter, the interval between chucks was increased at a speed of 50 mm/sec until the sample was broken. The strength at break was calculated by converting a peak top value of stress when the sample is broken into a value per dtex.

### (Adhesive Strength)

Using the threadlike adhesive bodies obtained in Examples and Comparative Examples, a circular acrylic plate 32 having a thickness of 3 mm and a diameter of 70 mm and a rectangular polycarbonate resin plate 31 (a short side of 80 mm, a long side of 110 mm, and a thickness of 10 mm) provided with a rectangular slit (a short side of 30 mm, and a long side of 40 mm) in a central portion thereof were bonded to each other such that a center of the acrylic plate 32 and a center of the slit of the polycarbonate resin plate 31 coincide with each other, and pressure-bonded at a load of 2 kg for 10 seconds. As shown in FIGS. 3 and 4, the threadlike adhesive body was disposed so as to have a length of 22 cm along an edge of the acrylic plate. FIG. 3 is a perspective view of the bonded state, and FIG. 4 is a cross-sectional view taken along a line A-A of FIG. 3.

Next, the polycarbonate resin plate 31 was fixed, and as shown in FIG. 4, a load was applied to the center of the acrylic plate 32 through the slit in a direction in which the acrylic plate 32 and the polycarbonate resin plate 31 were away from each other, and the maximum load observed before the acrylic plate 32 and the polycarbonate resin plate 31 were separated from each other was measured, thereby obtaining the adhesive strength (N/22 cm).

In Production Examples 1 to 3 in which the adhesive layer was provided, the strength at break was excellent as compared with Production Example 4 in which the adhesive layer was not provided and only the core material was provided. As a result of setting the tension in Production Example 1 to be lower than that of Production Example 2 at the time of forming the adhesive layer, a threadlike adhesive body having excellent appearance, high strength at break, and excellent strength was obtained in Production Example 1.

Although preferred embodiments of the present invention have been described above, the present invention is not limited to the above embodiments, and various modifications and substitutions can be added to the above embodiments without departing from the scope of the present invention.

The present application is based on Japanese Patent Application No. 2019-179185 filed on Sep. 30, 2019, the contents of which are incorporated by reference in the present application.

### REFERENCE SIGNS LIST

10, 13, 20, 30 Threadlike adhesive body
11 Bonded body
1 Adhesive layer
2 Core material
3 Filament
12A, 12B Article 31 Polycarbonate resin plate
32 Acrylic plate

1. A threadlike adhesive body comprising:
a threadlike core material and an adhesive layer configured to cover a circumferential surface of the core material in a longitudinal direction,
wherein the core material contains a recycled resin, and
a coverage rate of the circumferential surface with the adhesive layer is 50% or more.

2. The threadlike adhesive body according to claim 1, wherein the adhesive layer covers an entire circumference of a surface of the core material in the longitudinal direction.

3. The threadlike adhesive body according to claim 1, wherein the core material is a multifilament yarn including two or more filaments.

4. The threadlike adhesive body according to claim 1, wherein a twist coefficient K of the core material represented by the equation (A) is 0 or more and 200 or less
[Formula 1]
K=T/\sqrt{10000/D} (A)
(in the equation (A), K represents a twist coefficient, T represents the number of twists (unit:
[twists/m]), and D represents a fineness (unit: [dtex)]).

5. The threadlike adhesive body according to claim 1, wherein the number of twists of the core material is 0 to 250 twists/m.

6. A method for producing a threadlike adhesive body including a threadlike core material and an adhesive layer configured to cover a circumferential surface of the core material in a longitudinal direction, comprising
a step of forming the adhesive layer by applying a coating liquid to the circumferential surface of the core material in the longitudinal direction,
wherein the coating liquid has a solution viscosity of 0.03 to 6 Pa s under a condition of a shear rate of 100 (1/s) and a solution viscosity of 2 to 140 Pa s under a condition of a shear rate of 0.1 (1/s).

7. A method for producing a threadlike adhesive body including a threadlike core material and an adhesive layer configured to cover a circumferential surface of the core material in a longitudinal direction, comprising
a step of forming the adhesive layer by applying a coating liquid to the circumferential surface of the core material in the longitudinal direction,
wherein a tension of the core material during coating is 6 mN/dtex or less.

8. The method for producing a threadlike adhesive body according to claim 6, wherein the core material contains a recycled resin.

9. The method for producing a threadlike adhesive body according to claim 6, wherein the core material is a multifilament yarn including two or more filaments.
